(19) United States
(12) Patent Application Publication
(10) Pub. No.: US 2018/0297452 A1
(43) Pub. Date: Oct. 18, 2018

(54) SHADING DEVICE FOR A TWO-PART SIDE-WINDOW ARRANGEMENT OF A MOTOR VEHICLE

(71) Applicant: BOS GMBH & CO. KG, Ostfildern (DE)

(72) Inventor: Markus HINTENNACH, Baltmannsweiler (DE)

(21) Appl. No.: 15/737,958

(22) PCT Filed: Jun. 22, 2016
(86) PCT No.: PCT/EP2016/064358

§ 371 Date: Dec. 19, 2017

(30) Foreign Application Priority Data
Jun. 22, 2015 (DE) 10 2015 007 898.4

(51) Int. Cl. B60J 1/20

(52) U.S. Cl. CPC B60J 1/2083; B60J 1/2025; B60J 1/2069

(57) ABSTRACT

Shading device for a two-part side-window arrangement of a motor vehicle having a main shading structure for a main window and a secondary shading structure for a secondary window. The main shading structure is displaced between a rest position and a shading position and is retained on a winding shaft. The secondary shading structure is displaced, transversely to the main shading structure, between a rest position and a shading position. A drive system has a drive unit and a main drive train with two drive-transmission arrangements interacting with the main shading structure, and a secondary drive train with a drive-transmission arrangement for displacing the secondary shading structure. Drive elements for the drive-transmission arrangements are coupled to one another synchronously in a rotationally fixed manner via a synchronization shaft, and the synchronization shaft is mounted at a distance from the winding shaft and at least largely parallel thereto.

The invention relates to a shading device for a two-part side-window arrangement of a motor vehicle, having a main shading structure for a main window and having a secondary shading structure for a secondary window, wherein the main shading structure can be displaced, at least essentially in the vertical direction, between a rest position and a shading position and is retained on a winding shaft such that it can be wound up and unwound, and wherein the secondary shading structure can be displaced, at least essentially transversely to the main shading structure, between a rest position and a shading position, and having a drive system, which has a drive unit and a main drive train with two drive-transmission means, interacting with the main shading structure, and which has a secondary drive train with at least one drive-transmission means for displacing the secondary shading structure, which is in operative connection with the drive unit.

Such a shading device is known from EP 1 129 871 A1. The known shading device has a main shading structure provided for shading a main window of a side door of the motor vehicle. Also provided is a secondary shading structure, in order to shade a secondary window of the side door. The secondary shading structure can be displaced, transversely to the main shading structure, between a rest position and a shading position, wherein the main shading structure can be displaced in the vertical direction of the vehicle along the main window. Drive-transmission means in the form of thread-pitch cables are provided in order to displace the main shading structure between a rest position and a shading position, said cables running in window bars which flank the main window on opposite sides. Said cables displace a dimensionally stable pull-out profile of the shading structure essentially in the vertical direction of the vehicle. A drive-transmission means in the form of a control-lever arrangement, which can be displaced via a further thread-pitch cable, is provided for the secondary shading structure. The further thread-pitch cable, for displacing the control-lever arrangement, is led off from a drive system for the thread-pitch cables of the main shading structure via a control mechanism. The control mechanism serves to compensate for the pull-out path of the secondary shading structure, said path being shorter than that for the main shading structure.

It is an object of the invention to create a shading device of the type mentioned in the introduction which has a straightforward and space-saving construction.

This object is achieved in that drive elements for the two drive-transmission means of the main shading structure are coupled to one another synchronously in a rotationally fixed manner via a synchronization shaft, and in that the synchronization shaft is mounted at a distance from the winding shaft for the main shading structure and at least largely parallel thereto. There is no need for the winding shaft itself, according to the invention, to provide for any synchronization between the two drive-transmission means. Rather, this is done via a separate synchronization shaft, which is at a distance from the winding shaft and approximately parallel thereto. Accordingly, the winding shaft itself can have a small diameter and be of compact design. The solution according to the invention is particularly advantageously suitable for a side-window arrangement of a passenger vehicle, in particular in the region of a rear side door of the passenger vehicle.

In one configuration of the invention, the synchronization shaft is coupled to the drive unit via a gear mechanism, and the secondary drive train is led off coaxially from the synchronization shaft. A particularly straightforward construction of the drive system is made possible by virtue of the secondary drive train being led off coaxially. The coaxial arrangement, in addition, saves space.

In a further configuration of the invention, the secondary drive train has an output member which, on one side, is connected to the synchronization shaft coaxially and in a rotationally fixed manner. The output member is arranged preferably at the end of the synchronization shaft.

In a further configuration of the invention, on another side, the output member is connected to the at least one drive-transmission means of the secondary drive train via an articulation, of which the axis of rotation is oriented at an angle, in particular at right angles, to an axis of rotation of the synchronization shaft. The other side is preferably the opposite side of the output member, which deflects the transmission of torque from the synchronization shaft in the direction of the secondary drive train. The output member is provided to transmit corresponding torques at an angle. The output member is particularly advantageously designed in the form of a bevel-gear mechanism, in the form of a flexible transmission shaft or in the form of a universal-joint shaft or cardan shaft.

In a further configuration of the invention, the drive unit is coupled to the winding shaft, the synchronization shaft and the output member by means of a toothed-gear mechanism. The drive unit is advantageously an electric motor operated via a vehicle electric system and a suitable control mechanism.

In a further configuration of the invention, one end of the winding shaft and one end of the synchronization shaft are assigned two intermeshing spur gears. The spur gears are arranged preferably in alignment one above the other. The configuration provides for a straightforward and compact construction.

In a further configuration of the invention, the drive-transmission means provided for the secondary shading structure is in the form of a cable pull with two winding spools driven synchronously in opposite directions to one another. The operation of driving the two winding spools synchronously in opposite directions takes place preferably via two intermeshing spur gears which are arranged coaxially in relation to the respective winding spool and are assigned to the secondary drive train.

In a further configuration of the invention, the winding shaft is of conical configuration, and the drive-transmission means provided for the main shading structure are in the form of two cable pulls with conical winding spools which complement the conicity of the winding shaft such that, in dependence on the changing winding layers of the main shading structure on the winding shaft, uniform tensile loading of the cable pulls is maintained. Accordingly, the conicity of the conical winding spools is selected to run counter to a correspondingly decreasing or increasing roll provided by the winding layers of the winding shaft, depending on the winding-up or unwinding state of the main shading structure. Accordingly, a cable-winding diameter of the conical winding spools increases when a winding diameter of the winding layers of the main shading structure on the winding shaft decreases, the respectively effective diameters therefore being at least largely equal. This makes it possible for the two cable pulls to be moved in a largely tensioning-free manner.

In a further configuration of the invention, the winding shaft of the main shading structure and the toothed-gear mechanism of the drive unit have provided between them a spring-pretensioning mechanism, which pretensions the winding shaft in the winding-up direction. This avoids creasing of the main shading structure, which can occur as a result of tolerances when the shading device is fitted in the region of a corresponding side-window arrangement, or as a result of differences in temperature during operation of the shading device.

In a further configuration of the invention, a further spring-pretensioning mechanism is provided between a winding shaft of the secondary shading structure and the secondary drive train. The further spring-pretensioning mechanism has the same function as the spring-pretensioning mechanism for the winding shaft of the main shading structure.

Further advantages and features of the invention can be gathered from the claims and from the following description of a preferred exemplary embodiment of the invention, which is illustrated with reference to the drawings, in which:

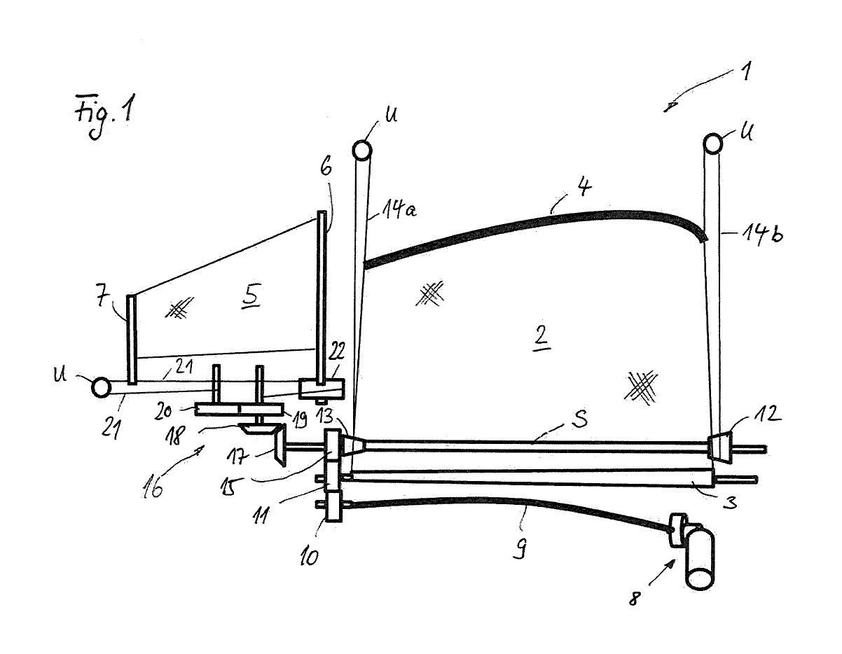

FIG. 1 shows, schematically, an embodiment of a shading device according to the invention, and

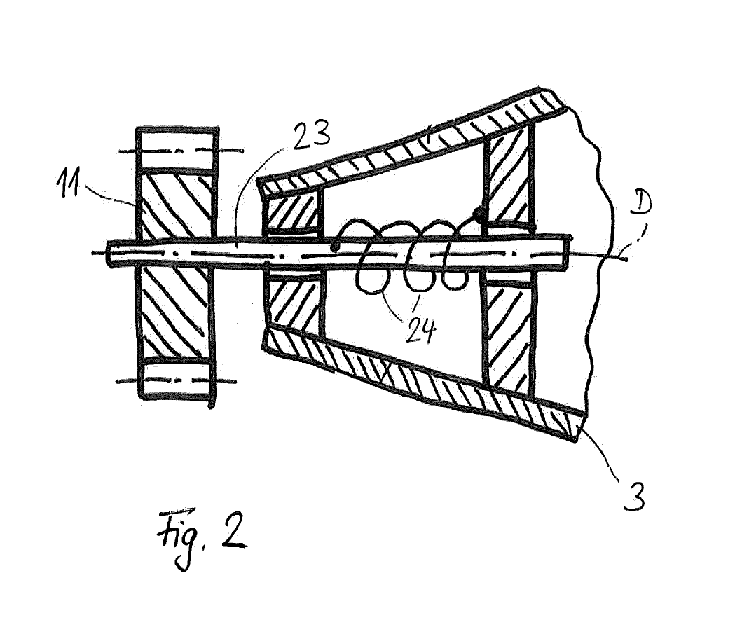

FIG. 2 shows, on an enlarged scale, a longitudinal section through a left-hand end region of a conical winding shaft for the shading device according to FIG. 1.

A shading device 1 according to FIGS. 1 and 2 is provided for a rear side door of a passenger vehicle. The side door has a two-part side-window arrangement. A main window of the side-window arrangement is separated from a smaller, secondary window by a window bar which extends approximately in the vertical direction of the vehicle. Opposite to the window bar, as seen in the longitudinal direction of the vehicle, the main window is bounded in the forward direction by a lateral door frame, which extends approximately in the vertical direction of the vehicle. An upper boundary of the main window is formed by an upper door frame, which continues beyond the secondary window. On the inside of the door, door-trim profiles are provided in the region of the window bar and of the door frame. An underside both of the main window and of the secondary window is bounded by an upper door panel arranged on the inside.

The shading device 1 is arranged in the region of the inside of the side door. The shading device 1 has a main shading structure 2, which is configured in the form of a web. The main shading structure 2 is retained on a conical winding shaft 3 such that it can be wound up and unwound. A front end region of the main shading structure 2, as seen in the pull-out direction, is provided with a dimensionally stable pull-out profile 4, which is curved in a manner corresponding to an upper peripheral contour of the main window and thus of the upper door frame. The winding shaft 3 is mounted on the door, beneath the upper door panel, such that it can be rotated about an axis of rotation D (FIG. 2). A conicity of the winding shaft 3 extends over the entire length of the winding shaft 3. The axis of rotation D of the winding shaft 3 extends essentially horizontally, and essentially in the longitudinal direction of the vehicle, as soon as the shading device 1 is fitted operationally in the region of an inner side of the side door of the passenger vehicle. The main shading structure 2 can be displaced between a rest position, in which it has been wound up onto the winding shaft 3, and a shading position, in which it has been pulled out upward approximately in the vertical direction of the vehicle and in which the shading structure 2 is mounted in place in a crease-free manner. In the shading position of the main shading structure 2, the pull-out profile 4 is positioned essentially flush in the region of the upper door frame.

For the purpose of shading the secondary window, the shading device 1 has a secondary shading structure 5, which is likewise flexible and configured in the form of a web and is retained on a winding shaft 6 such that it can be wound up and unwound, said winding shaft being mounted for rotation essentially in the vertical direction of the vehicle in the region of the window bar. The secondary shading structure 5 can be displaced, essentially transversely to a pull-out direction of the main shading structure 2, between a rest position, in which it has been wound up onto the winding shaft 6, and a shading position, in which it covers over the secondary window and in which the secondary shading structure 5 is mounted in place with surface-area coverage and in a crease-free manner. Both the secondary shading structure 5 and the main shading structure 2 cover over the secondary window and the main window, respectively, at least largely completely in the shading position, wherein a mounting plane of the secondary shading structure 5 and a mounting plane of the main shading structure 2 are oriented essentially parallel to the planes defined by the secondary window and the main window.

The secondary shading structure 5 is of trapezoidal configuration and has a dimensionally stable guide profile 7 at its front end region, as seen in the pull-out direction.

In order for it to be possible to displace both the main shading structure 2 and the secondary shading structure 5 between the rest position and the shading position, the shading device 1 is provided with a drive system, which will be described in more detail hereinbelow. The drive system has an electric drive motor 8, which uses a gear mechanism and a flexible shaft 9 to drive a drive gear 10, which is mounted in a rotatable manner in the region of the inside of the door. The drive gear 10 is designed in the form of a spur gear and has an axis of rotation which is oriented parallel to the axis of rotation D of the winding shaft 3. A further spur gear 11 is provided coaxially in relation to the axis of rotation D of the winding shaft 3 and, according to FIG. 2, is connected to the winding shaft 3 in a rotationally fixed manner. The spur gear 11 here is connected to the winding shaft 3 in a rotationally fixed manner via a spring-pretensioning mechanism 23, 24, which provides for the spur gear 11 to rotate to a limited extent relative to the winding shaft 3. For this purpose, the spur gear 11 is fastened on a pre-tensioning spindle 23, which is mounted in a rotatable manner, coaxially in relation to the winding shaft 3, in an end region of the winding shaft 3. Rotatability of the pre-tensioning spindle 23 is limited by a spring mechanism 24 in the form of a helical spring, which has one leg fastened on the pre-tensioning spindle 23 and an opposite leg fastened on a corresponding carrier flange of the winding shaft 3. As a result, the winding shaft 3 is retained in a state in which it is pretensioned permanently, and to a limited extent, in a winding-up direction relative to the spur gear 11, and therefore the main shading structure 2 is always subjected to a small amount of tensile loading in the winding-up direction.

In order for it to be possible to displace the pull-out profile, and therefore the main shading structure 2, between the rest position and the shading position, the drive system has a respective cable pull 14a, 14b on either side of the pull-out profile 4. The cable pull 14a and the cable pull 14b each act on one end of the pull-out profile 4, which can be displaced in a parallel state in lateral guides (not illustrated) along the window bar and the lateral door frame essentially in the vertical direction of the vehicle. The cable pulls 14a and 14b are also positioned in said lateral guides. One end of the respective cable pull 14a, 14b acts in the region of the corresponding end of the pull-out profile 4, while an opposite end of the respective cable pull 14a, 14b is retained for winding-up and unwinding action on a conical winding spool 12, 13. In addition, in an upper end region of the respective lateral guide, the two cable pulls 14a, 14b each have a deflecting roller U for the cable of the respective cable pull 14a, 14b. A corresponding conicity of the respective conical winding spool 12, 13 is selected such that a uniform level of tensioning for the respective cable pull 14a, 14b is provided permanently, irrespective of the number of winding layers of the main shading structure 2 wound up on the winding shaft 3 or unwound therefrom. In addition, the opposite winding spools 12 and 13 are configured with different conical forms, in order to compensate in addition for conicity of the winding shaft 3. Rotation of the winding spools 12, 13 results in corresponding displacements of the cable pulls 14a and 14b, as a result of which the pull-out profile 4 is displaced correspondingly upward or downward. The two winding spools 12, 13 are operated synchronously in relation to one another. A synchronization shaft S is provided for this purpose, the synchronization shaft extending at least largely parallel to the winding shaft 3 and being mounted in a rotatable manner on the inside of the door, above the winding shaft 3, but beneath the upper door panel. A spur gear 15 is connected to the synchronization shaft coaxially and in a rotationally fixed manner and is in alignment, as seen in the vertical direction of the vehicle, with the spur gear 11 and with the drive gear 10. The spur gear 15 meshes with the spur gear 11. Driving operation of the drive gear 10 via corresponding actuation of the electric drive motor 8, and corresponding rotation of the flexible transmission shaft 9, thus results in rotation of the winding shaft 3 and in rotation of the synchronization shaft S. The conical winding spools 12 and 13 serve to wind up the respective cable of the respective cable pull 14a and 14b on their outer, conical lateral surface, or to unwind the same therefrom. Since the conicity of the respective winding spool 12, 13 is coordinated with the different winding diameters of the main shading structure 2 on the winding shaft 3, in dependence on the number of winding layers wound up or unwound, the cable pulls 14a and 14b always retain a uniform level of cable tensioning when the pull-out profile 4 is displaced, by the drive motor 8, upward or downward between the shading position and the rest position. In addition, the spring-pretensioning mechanism 23, 24 results in the main shading structure 2 being subjected to a permanent, low level of tensile loading in the winding-up direction, and this therefore avoids creasing of the main shading structure 2, irrespective of fitting-related tolerances or differences in temperature during operation of the shading device 1.

The drive motor 8 also drives a secondary drive train 16, which is provided for displacing the secondary shading structure 5 between the rest position and the shading position. The secondary drive train 16 serves in the first place for displacing the guide profile 7 between the shading position and the rest position, wherein the guide profile 7 is displaced essentially transversely to the displacement direction of the pull-out profile 4 and thus, according to the embodiment of FIG. 1, essentially horizontally. Along with the displacement of the guide profile 7, the secondary drive train 16 serves to rotate the winding shaft 6 of the secondary shading structure 5 in the unwinding direction or in the winding-up direction. A cable pull 21 is provided in order to rotate the winding shaft 6 and to displace the guide profile 7 in a door-mounted guide in the region of the upper door panel, and therefore in the region of an underside of the secondary window, said cable pull acting on the guide profile 7 and having its opposite ends retained for winding-up and unwinding action on two cylindrical winding spools 19, 20. The two winding spools 19 and 20 are mounted such that they can be rotated synchronously and in opposite directions to one another. Synchronous and oppositely directed rotation of the two winding spools 19, 20 is achieved by a synchronization mechanism which, in the case of the exemplary embodiment illustrated, is provided by two intermeshing spur gears arranged coaxially in relation to an axis of rotation of the respective winding spool 19, 20. The cable of the cable pull 21 is deflected, at one end, over a deflecting roller U. At the opposite end, the cable of the cable pull 21 wraps around a deflecting roller 22, which is arranged coaxially and in a rotationally fixed manner in relation to the cylindrical winding shaft 6. From the one deflecting roller U, the cable is guided to the left-hand winding spool 20 in FIG. 1. Starting from the opposite deflecting roller 22, the opposite end of the cable is guided to the right-hand winding spool 19 in FIG. 1. Oppositely directed rotation of the two winding spools 19 and 20 results in the one end of the cable being wound up onto the winding spool 20 in each case, while the opposite end of the cable is unwound from the adjacent winding spool 19, and vice-versa. Corresponding diameters of the winding spools 19 and 20 are identical to one another, and this results in uniform cable tensioning being established when the cable pull 21 is displaced. Since the guide profile 7 is connected to the corresponding cable of the cable pull 21, rotation of the winding spools 19 and 20 inevitably results in the guide profile 7 being displaced to the left or to the right, as seen in the plane of the drawing of FIG. 1.

In order to couple the secondary drive train 16 to the drive motor 8, an output member 17, 18 is provided coaxially in relation to the synchronization shaft S and in a rotationally fixed manner in relation to the synchronization shaft S and the spur gear 15, said output member being connected coaxially and in a rotationally fixed manner to one end of the synchronization shaft S, and thus to one end of the spur gear 15, and in extension of the winding spool 13. The output member 17, 18 is formed by a bevel gear 17, which meshes with a further bevel gear 18, which is oriented at right angles to the axis of rotation of the bevel gear 17. The further bevel gear 18 is arranged coaxially and in a rotationally fixed manner in relation to the winding spool 19, and the drive torque of the drive motor 8 is thus deflected at right angles via the two bevel gears 17 and 18.

The electric drive motor 8 is energized and controlled to rotate the transmission shaft 9 of the shading device 1 according to FIG. 1, as a result of which the drive gear 10 rotates and meshes with the spur gear 11, which in turn meshes with the spur gear 15. As a result of being connected to the bevel-gear mechanism 17 and 18 in a coaxial and rotationally fixed manner, the two winding spools 19 and 20 are driven in opposite directions and synchronously in relation to one another, and this gives rise to all the cable pulls 14a, 14b and 21 for the main shading structure 2 and the secondary shading structure 5 being displaced simultaneously. In order also for the secondary shading structure 5 to be subjected to a certain level of permanent pretensioning, and therefore to be mounted in place in a crease-free manner, a spring-pretensioning mechanism analogous to FIG. 2 is provided between the deflecting roller 22 and the winding shaft 6, as is realized between the spur gear 11 and the winding shaft 3 for the main shading structure 2.

The cable pulls 14a and 14b serve, within the context of the invention, as drive-transmission means. The output member, within the context of the invention, is formed by the bevel gear 17, together with the bevel gear 18. The conical winding spools 12 and 13 constitute drive elements for the cable pulls 14a and 14b. The drive gear 10 and the two spur gears 11 and 15, within the context of the invention, form a gear mechanism. The two bevel gears 17 and 18, within the context of the invention, form a bevel-gear mechanism.

It is possible for the drive-transmission means for the main shading structure and the drive-transmission means for the secondary shading structure, instead of corresponding cable pulls, also to be in the form of other means for providing pulling and/or pushing motion, in particular in the form of belt drives or also thread-pitch cables.

The coaxial and rotationally fixed coupling between the bevel gear 18 and the winding spool 19 serves as an articulation within the context of the invention.

1. A shading device for a two-part side-window arrangement of a motor vehicle, having a main shading structure for a main window and having a secondary shading structure for a secondary window, wherein the main shading structure can be displaced, at least essentially in the vertical direction, between a rest position and a shading position and is retained on a winding shaft such that it can be wound up and unwound, and wherein the secondary shading structure can be displaced, at least essentially transversely to the main shading structure, between a rest position and a shading position, and having a drive system, which has a drive unit and a main drive train with two drive-transmission means, interacting with the main shading structure, and which has a secondary drive train with at least one drive-transmission means for displacing the secondary shading structure, which is in operative connection with the drive unit, wherein drive elements for the two drive-transmission means of the main shading structure are coupled to one another synchronously in a rotationally fixed manner via a synchronization shaft, and in that the synchronization shaft is mounted at a distance from the winding shaft for the main shading structure and at least largely parallel thereto.

2. The shading device as claimed in claim 1, wherein the synchronization shaft is coupled to the drive unit via a gear mechanism, and in that the secondary drive train is led off coaxially from the synchronization shaft.

3. The shading device as claimed in claim 2, wherein the secondary drive train has an output member which, on one side, is connected to the synchronization shaft coaxially and in a rotationally fixed manner.

4. The shading device as claimed in claim 3, wherein on another side, the output member is connected to the at least one transmission means of the secondary drive train via an articulation, of which the axis of rotation is oriented at an angle, in particular at right angles, to an axis of rotation of the synchronization shaft.

5. The shading device as claimed in claim 3, wherein the output member is designed in the form of a bevel-gear mechanism or in the form of a flexible transmission shaft.

6. The shading device as claimed in claim 1, wherein the drive unit is coupled to the winding shaft, the synchronization shaft and the output member by means of a toothed-gear mechanism.

7. The shading device as claimed in claim 1, wherein one end of the winding shaft and one end of the synchronization shaft are assigned two intermeshing spur gears.

8. The shading device as claimed in claim 1, wherein the drive-transmission means provided for the secondary shading structure is in the form of a cable pull with two winding spools driven synchronously in opposite directions to one another.

9. The shading device as claimed in claim 1, wherein the winding shaft is of conical configuration, and in that the drive-transmission means provided for the main shading structure are in the form of two cable pulls with conical winding spools which complement the conicity of the winding shaft such that, in dependence on the changing winding layers of the main shading structure on the winding shaft, uniform tensile loading of the cable pulls is maintained.

10. The shading device as claimed in claim 1, wherein between the winding shaft of the main shading structure and the toothed-gear mechanism of the drive unit, of a spring-pretensioning mechanism, which pretensions the winding shaft in the winding-up direction.

11. The shading device as claimed in claim 10, wherein a further spring-pretensioning mechanism is provided between a winding shaft of the secondary shading structure and the secondary drive train.
